(19) United States
(12) Patent Application Publication
(10) Pub. No.: US 2021/0352244 A1
(43) Pub. Date: Nov. 11, 2021

(54) SIMULATING REAL-LIFE SOCIAL DYNAMICS IN A LARGE GROUP VIDEO CHAT

(71) Applicant: Sony Interactive Entertainment LLC, San Mateo, CA (US)

(72) Inventors: Warren Benedetto, San Mateo, CA (US); Landon Noss, Mission Viejo, CA (US)

(21) Appl. No.: 16/871,763

(22) Filed: May 11, 2020

(51) Int. Cl. H04N 7/15; G06F 3/0481; G06F 3/0488; G06F 3/0486; G06F 3/0482

(52) U.S. Cl. CPC H04N 7/157; H04N 7/152; G06F 3/0482; G06F 3/04886; G06F 3/0486; G06F 3/04817

(57) ABSTRACT

A video chat system simulates real-life social dynamics by providing an onscreen map showing icons representing a potentially large number of people in the chat while permitting smaller groups of users to engage in conversations while viewing videos and hearing audio from members of the smaller group. Users can move between groups by moving their icons on the map, as people might circulate around a large room in a real-life gathering.

### FIELD

The present application relates to technically inventive, non-routine solutions that are necessarily rooted in computer technology and that produce concrete technical improvements.

### BACKGROUND

As COVID-19 has ground much of the world to a standstill, the number of people using video chat for work and play has skyrocketed. One of the resulting phenomena is large groups of people getting together for a “virtual happy hour” or a “virtual birthday party” or similar. As understood herein, a problem is that video chat applications are not designed to make communication between that many people actually work. Every person's video is visible at the same size (often very small), everyone can hear everyone else talking at the same volume, everything said and done is visible and audible to everyone else at all times.

### SUMMARY

The result of the above is that large group video chats end up quickly disintegrating into many separate smaller video chats. Subgroups spin up their own calls with select people. There is no easy way for others to know those calls exist, or who is in them. There is no way to easily move between calls. There is no easy way to seamlessly rejoin the main call.

In contrast, in a real-life large group meeting there may be dozens if not hundreds of people in a room, but an attendee would not be talking to all of them at once. People tend to gravitate to smaller groups of a handful of people, having a relatively constrained conversation. People would not be able to see or hear most of the people in the party, even if they are technically “there.” Other groups would be scattered around the space. If a person wishes to move from one conversation to another, the person walks over to a different group, which is possible because people can see who is talking to whom from across the room and thus can preemptively decide whether to join them without first hearing what they're talking about. Moreover, people can engage in quick private conversations by drawing close to each other and whispering or stepping away from the group for a minute to talk, then quickly re-join. People can stroll around the room to check out who is there, lurking nearby to sample the conversation before deciding to join it. If one group is not talking about something interesting, a person could stroll past another. Real life social dynamics such as these are sought to be provided in a virtual chat.

Accordingly, an assembly includes at least one display, at least one network interface, and at least one processor configured with instructions to receive information via the network interface pertaining to plural chat participants. The instructions are executable to, using the information, present on the display a user interface (UI). The UI includes a map window showing icons or avatars each respectively representing a chat participant, such that all of the plural chat participants are represented on the map window by a respective icon or avatar. The UI further includes a video chat window that is separate from the map window and that presents videos of respective users in a subgroup of chat participants. The users in the subgroup are less than all of the plural chat participants, and the subgroup may be established based at least in part on proximity. In example implementations, the proximity is based at least in part on proximity of respective icons or avatars to each other in the map window.

In some embodiments the assembly includes at least one speaker and the instructions are executable to present on the speaker audio from users in the subgroup but not from other chat participants not in the subgroup.

In example embodiments the UI can includes a list window presenting a list of all chat participants represented in the map window.

In non-limiting implementations the instructions may be executable to present the map window in a primary region of the display and present the video chat window in a sidebar portion of the display, and then responsive to user input, present the map window in the sidebar portion of the display and present the video chat window in the primary region of the display.

In examples discussed further herein, the display may include a two-dimensional video display, or it may include a virtual reality (VR) or augmented reality (AR) head-mounted display (HMD).

In some implementations the instructions can be executable to configure the video chat window of the respective users in the subgroup of chat participants in a public mode, in which a first chat participant moving a respective icon into proximity of the subgroup can see videos of the users in the subgroup and hear audio from the users in the subgroup. The instructions may be executable to configure the video chat window of the respective users in the subgroup of chat participants in a private mode, in which the first chat participant moving a respective icon into proximity of the subgroup cannot see videos of the users in the subgroup or hear audio from the users in the subgroup. The instructions also may be executable to, responsive to a request from the first chat participant to enter the subgroup while in the private mode, present on a display of at least one of the users in the subgroup an interface to reject or accept the first chat participant.

In examples, the instructions may be executable to present on a display associated with a first chat participant a list of chat participants represented by respective avatars or icons in the map window. The instructions also may be executable to move the respective avatar or icon of the first chat participant to a location in the map window of an avatar or icon of a second chat participant selected from the list.

In another aspect, a method includes presenting on respective display devices of respective chat participants a video chat application simulating real-life social dynamics at least in part by providing an onscreen map to each display device showing pawns representing respective chat participants. The method includes permitting users in subgroups of the chat participants to engage in conversations while viewing videos and hearing audio from members of the respective subgroups. Further, the method includes moving chat participants between subgroups responsive to the respective chat participants moving their pawns on the map.

In another aspect, a system includes at least one video chat server and plural devices communicating with the chat server. Each device is associated with a respective user. The system also includes at least one processor configured with instructions to present on each device a map with pawns representing the respective users. The instructions are executable to present on at least one device a video chat window along with the map and showing video of at least first and second users based on respective first and second pawns being proximate to each other on the map.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIGS. 1a and 1b respectively illustrate the two principal views (map and conversation);

FIGS. 2a-2e illustrate a chat user moving between sub-groups;

FIGS. 3a and 3b illustrate a whisper mode;

FIGS. 4a and 4b illustrate a person attempting to enter a private conversation;

FIGS. 5a-5d illustrate a “wave” function to permit a user to request to join a private chat sub-group;

FIGS. 6a-6i illustrate a “knock” function to permit a user to request to join a private chat sub-group;

FIGS. 7a-7f illustrate a “shout” function to permit a user to request to join a private chat sub-group;

FIGS. 8a-8c illustrate a teleport function;

FIGS. 9a-9d illustrate a pull function;

FIGS. 10a-10c illustrate a wander function;

FIGS. 11a-11g illustrate aspects of public and private conversations;

FIG. 12 is a screen shot of a portion of a user interface showing an indicator of a conversation;

FIG. 13 is a screen shot of a head-mounted display (HMD) presentation; and

FIG. 14 is a flow chart of example logic attendant to FIG. 13.

### DETAILED DESCRIPTION

This disclosure relates generally to computer ecosystems including aspects of consumer electronics (CE) device-based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft or Unix or Apple, Inc. or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be a single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

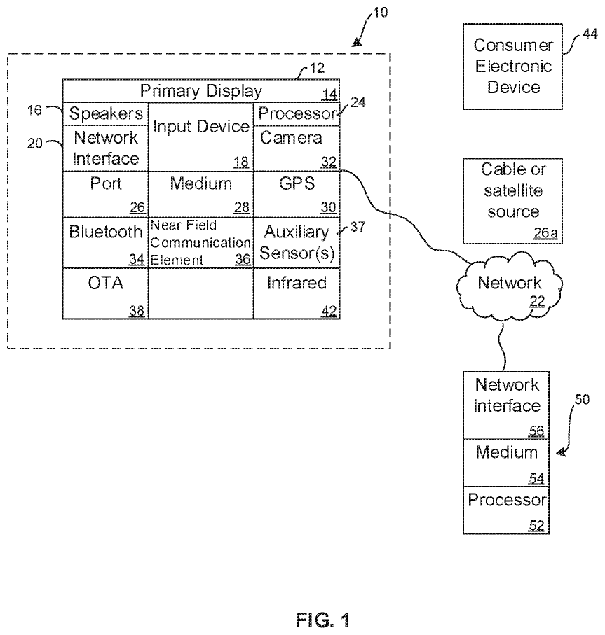

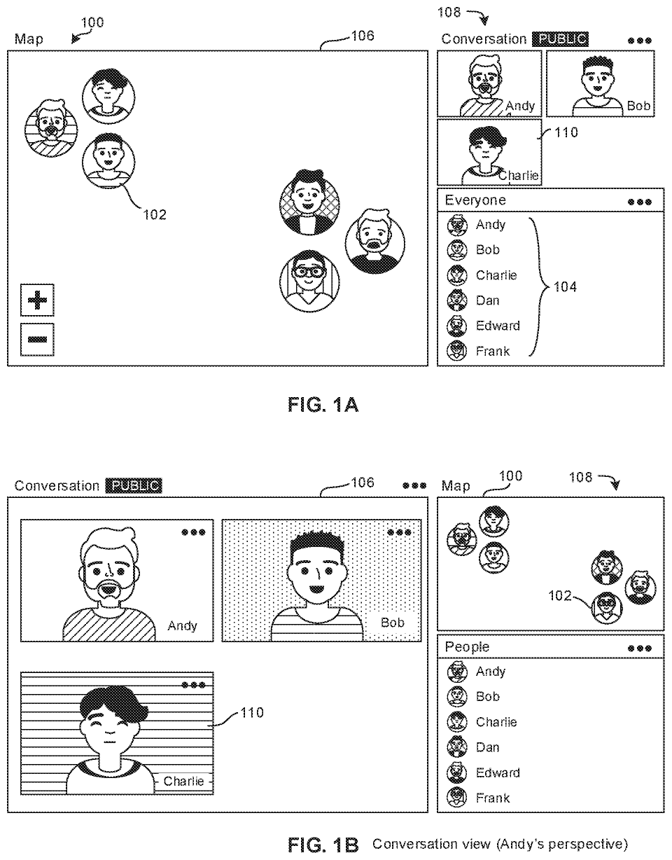

Now specifically referring to FIG. 1, an example ecosystem 10 is shown, which may include one or more of the example devices mentioned above and described further below in accordance with present principles. The first of the example devices included in the system 10 is an example primary display device, and in the embodiment shown is an audio video display device (AVDD) 12 such as but not limited to an Internet-enabled TV. Thus, the AVDD 12 alternatively may be an appliance or household item, e.g. computerized Internet enabled refrigerator, washer, or dryer. The AVDD 12 alternatively may also be a computerized Internet enabled (“smart”) telephone, a tablet computer, a notebook computer, a wearable computerized device such as, e.g., a computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or “8K” (or higher resolution) flat screen and that may be touch-enabled for receiving consumer input signals via touches on the display. The AVDD 12 may include one or more speakers 16 for outputting audio in accordance with present principles, and at least one additional input device 18 such as a keyboard or keypad or an audio receiver/microphone for e.g. entering audible commands to the AVDD 12 to control the AVDD 12. The example AVDD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a USB port to physically connect (e.g. using a wired connection) to another CE device and/or a headphone port to connect headphones to the AVDD 12 for presentation of audio from the AVDD 12 to a consumer through the headphones. The AVDD 12 may further include one or more computer memories 28 that are not transitory signals, such as disk-based or solid-state storage (including but not limited to flash memory). Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command, etc.) providing input to the processor 24. The AVDD 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still referring to FIG. 1, in addition to the AVDD 12, the system 10 may include one or more other CE device types. In one example, a first CE device 44 may be used to send messages to a second CE device 46 may include similar components as the first CE device 44 and hence will not be discussed in detail. In the example shown, only two CE devices 44, 46 are shown, it being understood that fewer or greater devices may be used.

The example non-limiting first CE device 44 may be established by any one of the above-mentioned devices, for example, a portable wireless laptop computer or tablet computer or notebook computer or mobile telephone, and accordingly may have one or more of the components described below. The second CE device 46 without limitation may be established by a wireless telephone. The second CE device 46 may implement a portable hand-held remote control (RC). The second CE device 46 may implement virtual reality (VR) and/or augmented reality (AR) a head-mounted display (HMD). The CE devices 44, 46 may include some or all of the components illustrated in the case of the AVDD 12.

At least one server 50 may include at least one server processor 52, at least one computer memory 54 such as disk-based or solid-state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server and may include and perform “cloud” functions such that the devices of the system 10 may access a “cloud” environment via the server 50 in example embodiments. Or, the server 50 may be implemented by a game console or other computer in the same room as the other devices shown in FIG. 1 or nearby.

Devices discussed herein may include some or all, as appropriate, of the various components shown in FIG. 1.

Turn now to FIG. 1A, illustrating a screen shot of a chat user's device (in the example shown, user “Andy”) that includes a map 100 representing every person in a large group chat as an avatar or an icon 102. These avatars or icons 102 may be referred to herein as “pawns”. The pawns can be move freely around the map by the users associated with the respective pawns using various navigation mechanisms, including point and click, directional navigation, or “teleporting” by clicking the name of a person in a list and being automatically moved to that person's location on the map.

A pawn's location on the map relative to other pawns determines which video chats will be visible and which audio will be audible to any given user. In other words, proximity to others determines who users see and hear, just like in real life. People who are farther away on the map are still “there,” but audio and video of the respective users are not presented to a particular user unless the particular user is “close.”

To illustrate, FIG. 1 assumes there are six people in the chat and, hence, on the map 100 as illustrated by their pawns on the map 100 and on a list 104: Andy, Bob, Charlie, Dan, Edward, and Frank. On the 2D map 100, the pawns for Andy, Bob, and Charlie are clustered together in a group in the upper left corner of the map. Meanwhile, the pawns for Dan, Edward, and Frank are clustered together in a group in the lower right corner of the map.

FIG. 1a shows a Map View, where the Map is the primary visual focus by virtue of being located in a primary window 106. The video chat conversation is relegated to a sidebar 108 in which (for user Andy, who is nearby Bob and Charlie) video panes 110 are presented in the sub-group formed by Andy, Bob, and Charlie. It is to be understood that the videos and audio of users is captured by cameras and microphones on the respective user devices and shared, typically over a network, with the devices of other users in the chat. Likewise, pawn navigation signals can be sent between devices.

FIG. 1b shows a Conversation View, in which the video chat conversation has been moved is the primary window 106 and the map 100 is relegated to the sidebar 108. This is likely to be the primary view for most users, most of the time. To swap between map and conversation views, the user may, for example, double-click on either the primary window 106 or the sidebar 108.

Because Andy, Bob, and Charlie are near each other on the map, they can all see each other's video chat 110 and hear each other's audio. But Dan, Edward, and Frank are too far away on the other corner of the map, so their video and audio is hidden and muted. In other words, Andy, Bob, and Charlie can see and hear each other, but they cannot see or hear Dan, Edward, and Frank except for the pawns 102 in the map 100 shown in the sidebar 108.

Likewise, Dan, Edward, and Frank are near each other, so they can see and hear each other, but cannot see or hear Andy, Bob, and Charlie.

Now, suppose Andy is tiring of his conversation with Bob and Charlie. He can look at the map and see that Dan, Edward, and Frank are talking together somewhere else. He is friends with those guys, so he knows he can feel comfortable joining their conversation. Because he can see on the map who is talking together ahead of time, he can preemptively decide to join before actually joining.

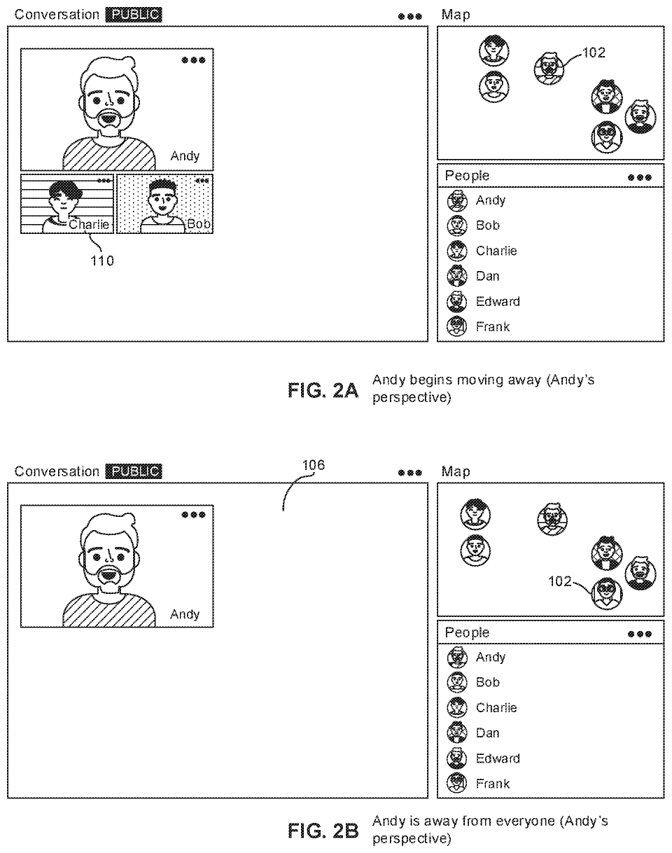

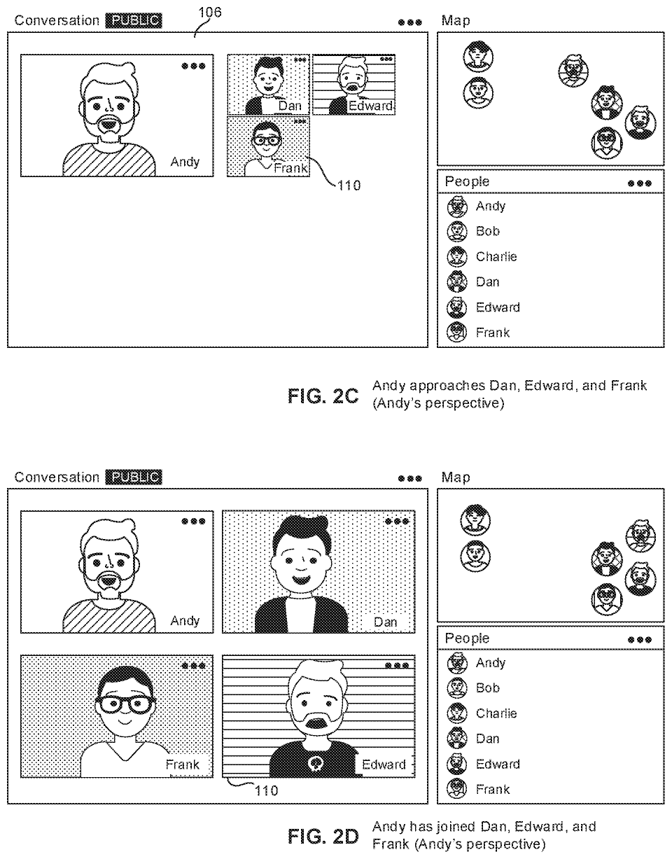

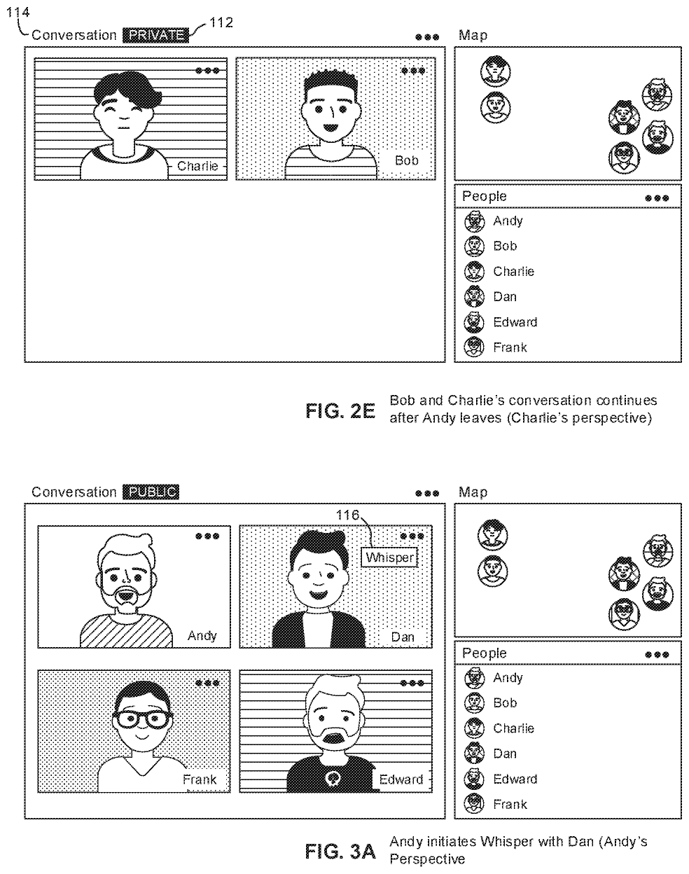

To leave his conversation with Bob and Charlie, Andy simply needs to navigate far enough away from them on the map. As his distance from them grows, their video chat windows 110 shrink as shown in FIG. 2a, and the audio volume from Bob and Charlie decreases on Andy's device.

FIG. 2a shows Andy's pawn 102 on the map 100 moving away from Bob and Charlie, to their right. Because he is getting farther away, Charlie and Bob's video gets smaller and their volume decreases.

Once Andy has exceeded a maximum distance, Bob and Charlie's video and audio is hidden altogether on Andy's device. Andy is now distanced from the other users as shown in FIG. 2b illustrating (on Andy's device) Andy's pawn isolated in the center of the map and, in the primary window 106, no videos of other users other than Andy himself.

FIG. 2c illustrates that the reverse is true as Andy approaches Dan, Edward, and Frank's group on the map. When Andy's pawn arrives at a threshold distance from Dan, Edward, and Frank, their video 110 and audio becomes visible in the primary window 106 at small size and low volume because Andy's pawn is still a bit far away, whereas when Andy's pawn has been moved within a closer threshold distance of Dan, Edward, and Frank as shown in FIG. 2d, Dan, Edward, and Frank's videos 110 are presented in full size and their audio is played at full volume. Andy has now seamlessly joined their conversation. Andy, Dan, Edward, and Frank can now all hear and see each other.

Meanwhile, as illustrated in FIG. 2e (showing Charlie's device), Bob and Charlie's conversation has continued unimpeded. They just saw Andy's video chat shrink and disappear as his pawn moved away from them on the map while continuing their conversation without Andy. Their conversation is now private, as indicated by the tag 112 in the Conversation header 114 (note that in FIGS. 2a-2d the conversation tag 112 is “public”, indicating more than two people in the sub-group as discussed further herein). This functionality is the equivalent of walking from a conversation in one room of a house to join a conversation in another room in the house.

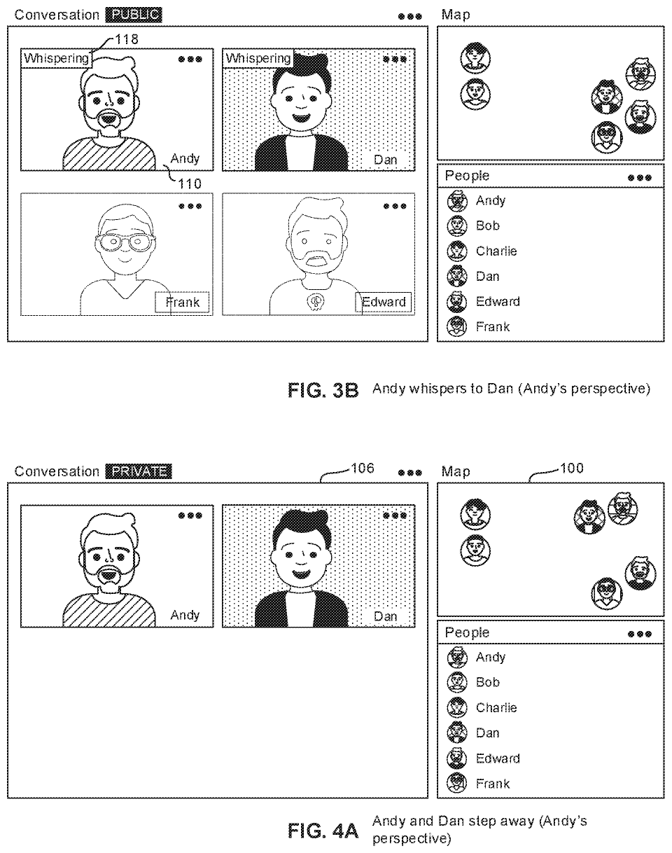

Refer now to FIG. 3a, illustrating a whisper mode as presented on Andy's device. Andy, Dan, Edward and Frank are in a four-way group conversation, and if Andy wants to quickly tell Dan something he doesn't want the others to hear, he can select an Options menu on Dan's video and choose to “whisper” to him. This whisper function sends Andy's audio only to Dan's device, with a visual indicator 116 on screen to let Dan know this is a whisper only he can hear. Dan can then select Andy's video Options menu to whisper back, with audio that only Andy can hear. This function allows for quick one-on-one communication between users within a sub-group, without disruptive overlapping audio intruding on the group chat.

FIG. 3b shows Andy whispering to Dan as indicated to both users on their respective devices by the “whispering” tag 118 presented on both of their video images 110. Frank and Edward, although in the same sub-group, cannot hear what Andy says to Dan while in the whisper mode.

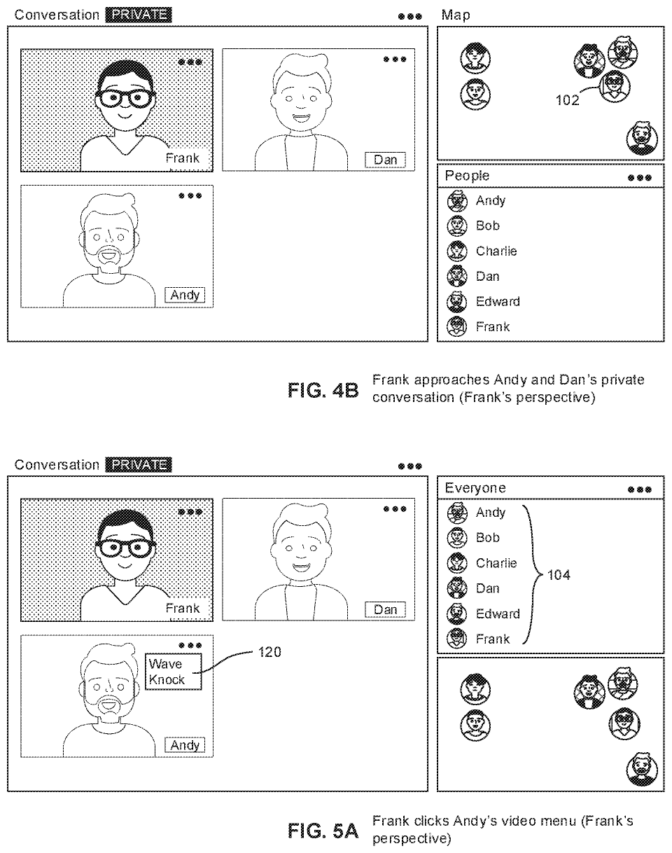

The whisper is just for a quick chat, a few words here and there. But what if Andy and Dan want to have a more in-depth private conversation? Continually using the whisper is inconvenient and potentially disruptive to the larger group conversation. Andy and Dan can choose to simply “step aside” to have a private conversation. To do this, they both simply move their pawn on the map to an area further away from any other group, as shown in FIG. 4a illustrating Andy and Dan's pawns 102 moving away to the top right of the map. Because they have moved a threshold distance away from the others, they can now only see and hear each other in the primary window 106. The Private tag 112 next to the Conversation header indicates that their conversation is private. Once Andy and Dan are both far enough away from everyone else, but close to each other, they have effectively created their own separate chat sub-group. Andy and Dan can now converse privately without disrupting the rest of the original group; Edward and Frank's conversation can continue uninterrupted by Andy and Dan's crosstalk and side chatter.

Any conversation between two people alone can be private by default. What that means is, if another pawn moves close to a pair of pawns on the map, that third pawn will not be able to see or hear the video of the pair right away. For example, Andy and Dan step away to have a private chat. Frank moves his pawn near them. Frank will not be able to see or hear Andy and Dan by default. FIG. 4b (Frank's device presentation) shows that Frank's pawn 102 has moved within proximity (threshold distance on the display) of Andy and Dan in the upper right of the map 100. However, because it is a private one on one conversation between Andy and Frank, Frank cannot see or hear the videos and audios of Andy and Dan. Should a pair of private chatters choose to make their conversation public so that others may freely join, an Options menu may be invoked that controls settings for the conversation. Either member of the pair can select the Options menu and choose Make Public. This will send a Make Public request to the other member. The other member can then choose to accept or reject the request.

For example, if Andy and Dan are in a private conversation, Andy can click Options and select Make Public. Dan receives the request. If he accepts, the conversation is public. Once public, any other pawn can move close on the map and be automatically joined to the conversation. If Dan rejects the request, the conversation remains private.

Once made public, a conversation can be made private again in the same way. One member of the pair selects Options and chooses Make Private. Once the other accepts that Make Private request, the conversation is private again.

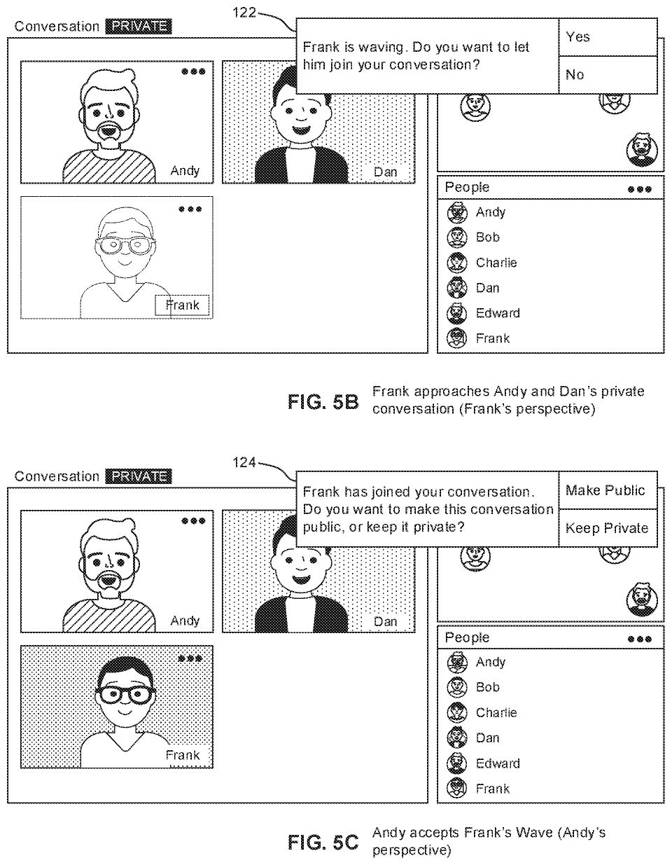

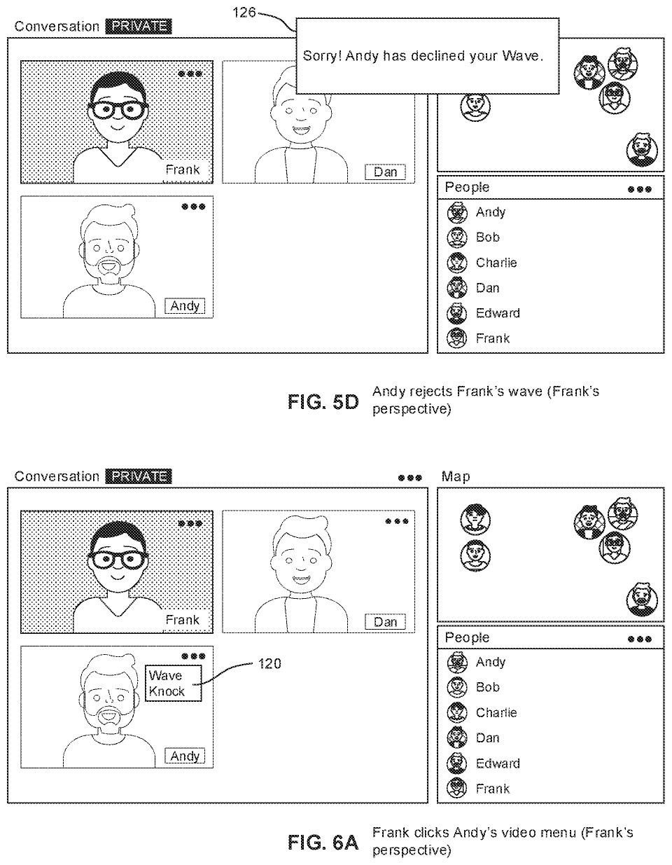

Returning to Frank, who has approached the private chat between Andy and Dan, Frank may be permitted to request to join the conversation using one or more request modes, with examples referred to herein as “wave” and “knock”. FIG. 5a illustrates a situation in which Frank is just casually interested in joining Andy and Dan and so he may select Andy's or Dan's pawn and choose to Wave from a request menu 120. This signals the selected user that someone wants to join the private conversation. The selected user can then allow or reject that Wave. FIG. 5a shows Frank clicking the dot menu on Andy's video in Frank's list 104 to open the Options menu 120 with the Wave option.

FIG. 5b shows Andy receiving Frank's wave, with the option 122 to allow Frank to join the conversation, or not. Thus, if Frank waves to Andy, Andy can accept the Wave. This allows Frank to join the conversation, and he can then see and hear both Andy and Dan, and they can see him as illustrated in FIG. 5c showing that Frank has been added to Andy and Dan's conversation as indicated to Andy at 124. Frank can now see and hear Andy and Dan's conversation. This figure also shows an alert about privacy which is discussed further below.

If Andy chooses to reject Frank's Wave, then Frank receives back a message 126 as shown in FIG. 5d letting him know that it is a private conversation and he cannot join. This is the equivalent as waving to someone from across the room as you approach their conversation. It gives them the opportunity to “wave you off” before you intrude on something private.

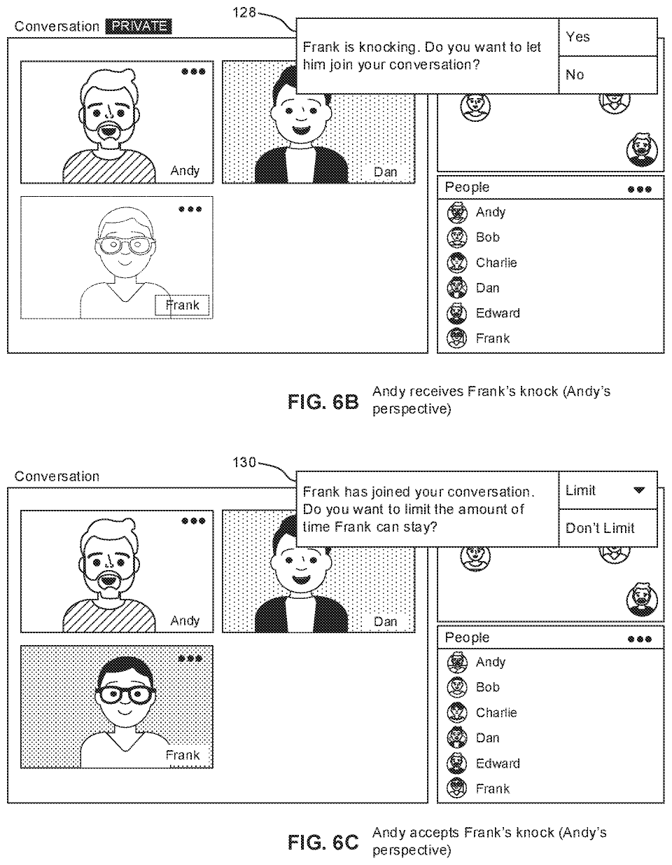

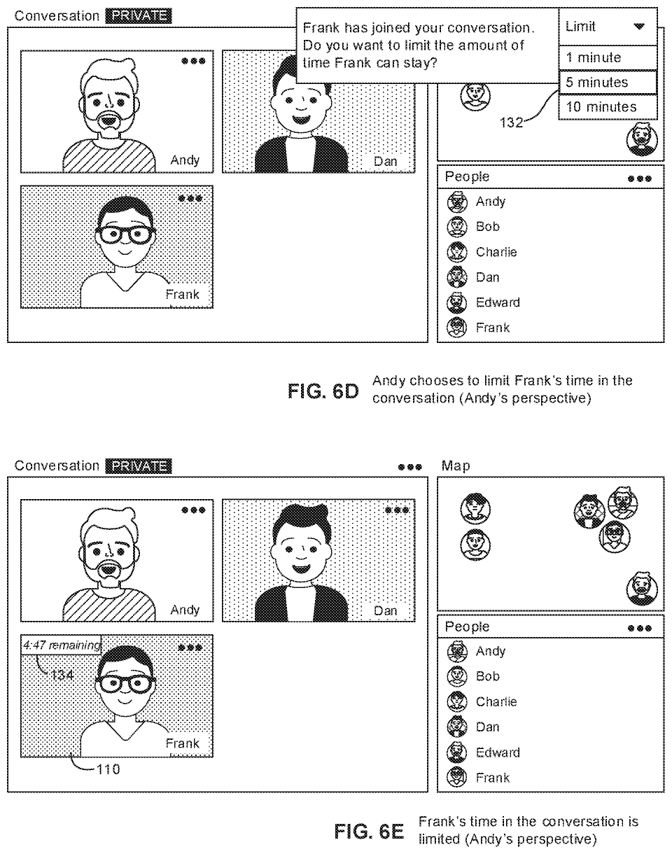

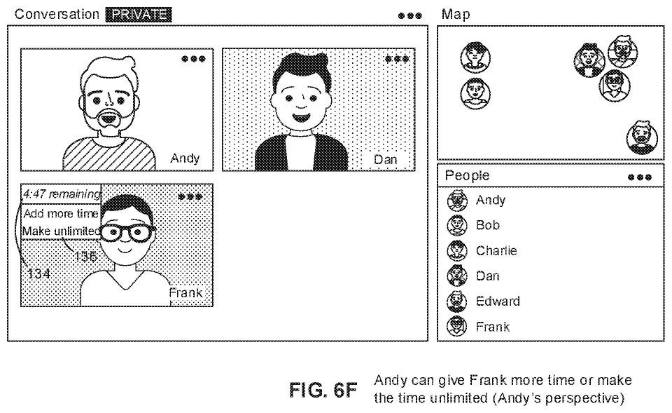

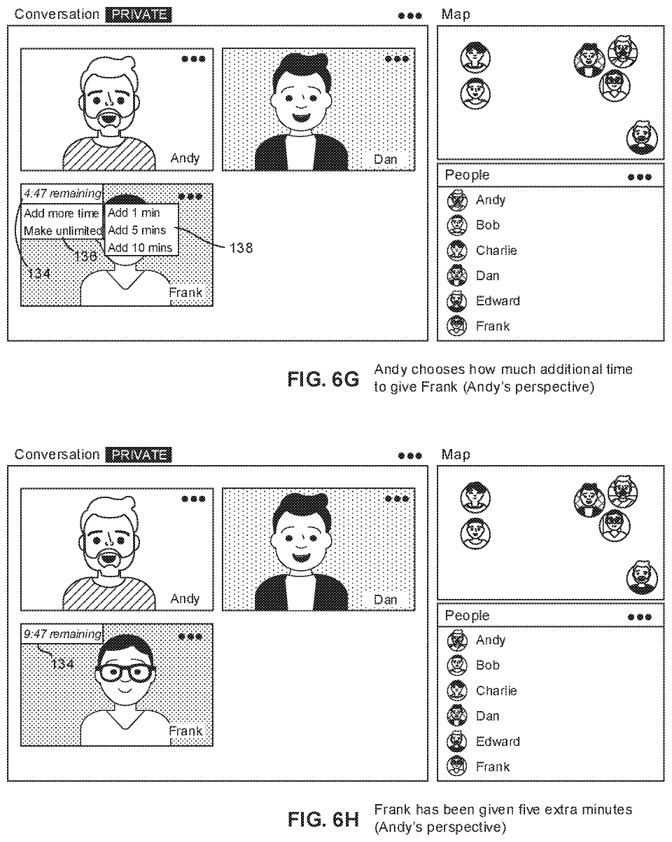

Present principles understand that a user (such as Frank in the example below) may wish to urgently join a private conversation, and so a Knock function is provided. As with a Wave, Frank can select Andy or Dan's pawn and select Knock from the menu 120 shown in FIG. 6a. This signals the selected user that someone wants to join the private conversation, and it is urgent.

The selected user can then allow or reject that Knock. Just like with a wave, Andy accepting Frank's Knock allows Frank to see/hear Andy and Dan, and vice versa. If Andy was to reject Frank's Knock, then Frank would receive a message back saying he cannot join. FIG. 6b shows the message 128 that Andy receives, letting him know Frank is knocking. Andy can choose to accept the knock and let Frank join the conversation, or not. The difference between a Knock and a Wave is the urgency. A Knock notification is visually distinguished as being more urgent, e.g., by being presented in red or other bright color and/or by being presented with larger font text than a wave and/or by using a distinctive audio output.

A Knock can also be accepted in more than one way. When Andy accepts Frank's Knock, he can choose to do it for a limited time, for example one minute, five minutes, ten minutes, or unlimited. This gives Andy and Dan the option to include Frank in their private conversation for a short time to hear what he has to say, before the conversation reverts back to being private.

FIG. 6c shows Andy accepting Frank's knock. Frank is added to the conversation, so he can now hear and see Andy and Dan's conversation. Andy is then given an option 130 to limit the amount of time Frank is allowed to stay in the conversation. If Andy accepts Frank's Knock for one minute, then Frank can see/hear Andy and Dan for only one minute, after which he will not see the videos or hear the audio from Andy and Dan. A visible timer will let everyone know how much time Frank has left. FIG. 6d shows that Andy has selected Limit on the notification. He is then given options 132 for how long he wants to allow Frank to remain in the conversation. FIG. 6e shows a countdown 134 over Frank's video 110 of the remaining time that Frank can remain in the conversation. When that timer expires, Frank will no longer be able to see/hear Andy or Dan anymore.

At any time, Andy can select the timer to either add more time or make it unlimited. FIG. 6f shows Andy clicking the countdown timer 134 on Frank's video to show options 136 to add more time or make the time unlimited.

FIG. 6g shows Andy using a menu 138 to choose to add more time for Frank to stay in the conversation. FIG. 6h shows that five minutes have been selected from the menu 138 to add five minutes to timer 134. In contrast, FIG. 6i shows that Frank has been given unlimited time by Andy. As a result, the countdown timer has been removed from his video. This is the equivalent of people having a private conversation in a room with the door closed. A person can knock to request entry and “poke his head in” to tell them something important. They can then “close the door” to continue talking privately.

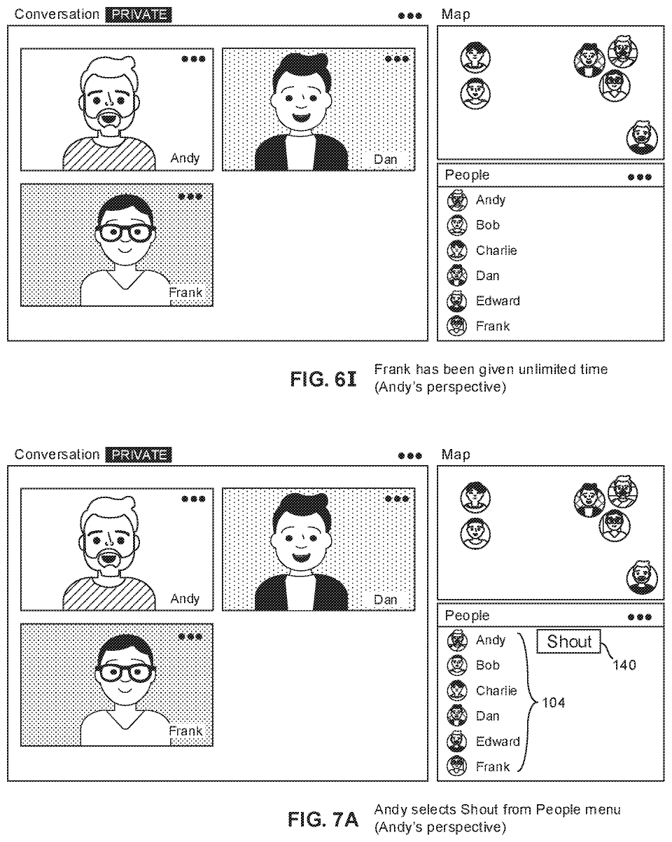

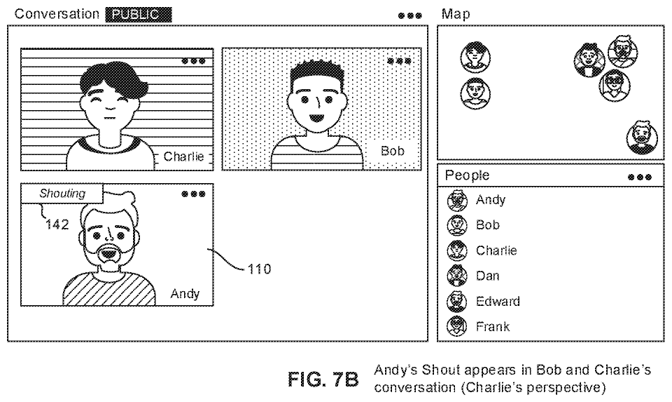

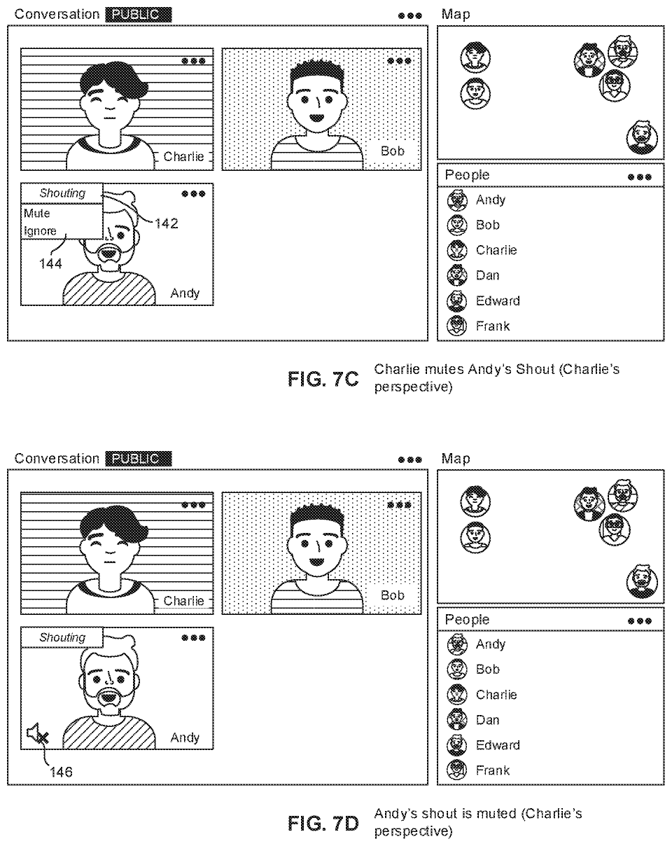

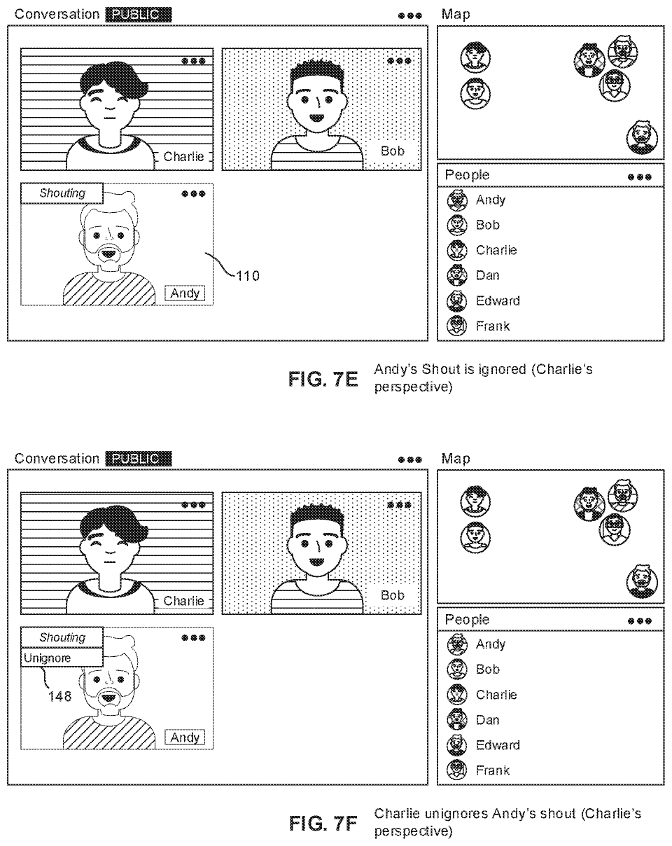

Refer now to FIGS. 7a-7f. Recognizing that in a large group setting it may be necessary to get the attention of everyone in the room, a shout function is provided. A Shout should be used judiciously since it can be disruptive to everyone. This may mean that only certain people in the chat may be allowed to shout, or that shouts are limited in some way (one shout per hour, one shout per person, minimum N minutes between shouts, etc.)

In the example shown, a shout selector 140 is presented on the people menu or list 104. The user selecting shout appear in every group's video chat, regardless of privacy. However, it is unidirectional in that everyone can hear and see video and audio of the person shouting, but the person shouting cannot see or hear everyone else. This preserves the privacy of the private groups.

For example, say Andy, Dan, and Frank are in a conversation, and Andy wants to let everyone in the room know he is leaving. He can use a Shout to say his goodbyes. This would make Andy's video appear in Bob and Charlie's chat, even though Andy is nowhere near them. Andy can say his goodbyes to everyone, then log off for the night.

FIG. 7a shows that Andy has clicked the dot menu in the People list to show the menu containing the Shout option 150. FIG. 7b shows a video 110 of Andy appearing in Bob and Charlie's conversation along with an indicator 142 that Andy is shouting. Bob and Charlie can see and hear Andy, but Andy cannot see or hear Charlie and Bob.

Shouts can be muted or ignored. If Andy uses a shout, Bob and/or Charlie can mute him, which kills his audio while leaving his video still visible. Or they can ignore him, which will kill the audio and video. Mute and ignore are both reversible, to bring back the Shout's audio and/or video on demand. FIG. 7c shows Charlie selecting the Shouting indicator 142 on Andy's video to open a menu 144, giving him the option to Mute or Ignore Andy. FIG. 7d shows that Andy's Shout has been muted, as indicated by the mute icon 146 in the lower left corner of Andy's video. FIG. 7e shows that Andy's Shout has been ignored: the audio is muted and the video 110 of Andy is hidden or grayed out. FIG. 7f shows Charlie clicking Andy's ignored Shout to open a menu 148 which gives him the option to unignore the Shout. Once unignored, the Shout will return to its original state (FIG. 7b).

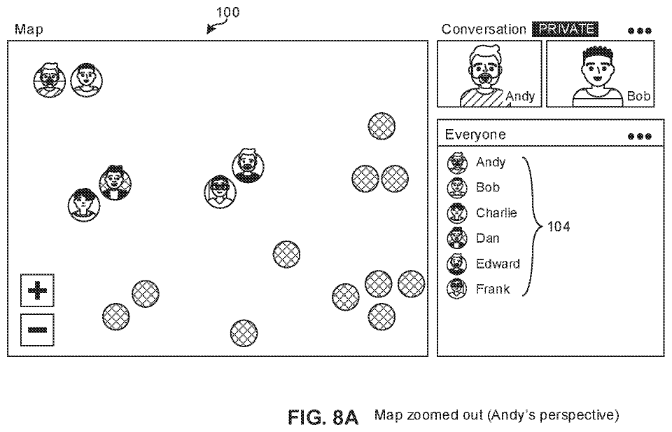

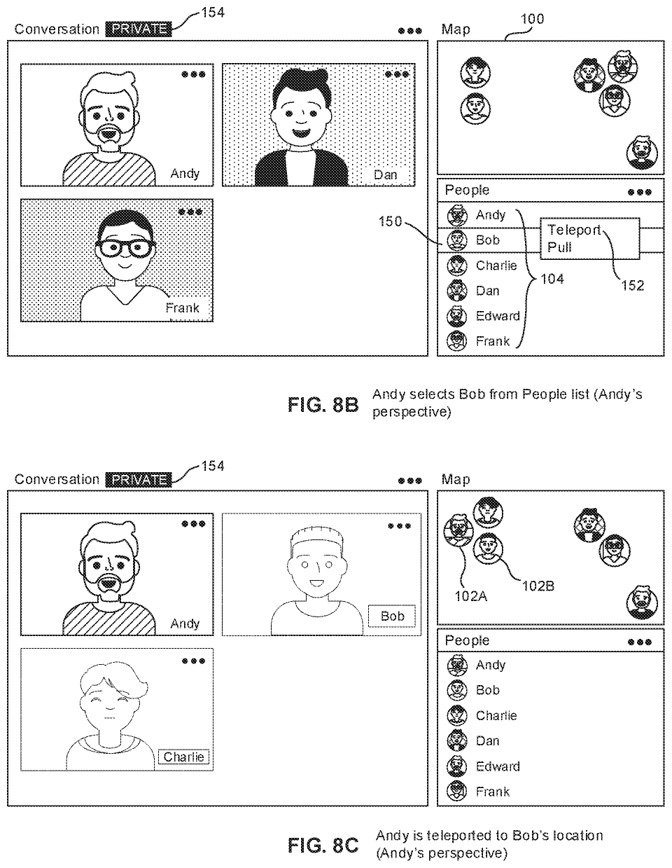

Refer now to FIGS. 8a-8c. In the examples above only six people are assumed for simplicity. In the case of a much larger overall group, e.g., one hundred people, the map 100 is much larger as shown with many more pawns, with many more groups and pairs of varying sizes.

FIG. 8a shows a larger map with more pawns. (Anonymous pawns are represented as empty gray circles in this illustration.) As understood herein, it may be difficult to locate the pawn of a particular person one may wish to converse with on a large map with many pawns and groups. At a real-life event, Andy might have to wander around a house from room to room until he finds Bob, to whom he wishes to speak. As shown and described herein, however, Andy need not wander his pawn but can instead Teleport.

To do that, Andy can look at the list 104 of all the participants in the party, for example in a sidebar that lists the participants alphabetically. Andy can simply find Bob in the list as shown at 150 in FIG. 8b, click his name and select Teleport 152. Andy's pawn will then be automatically moved on the same position as Bob's pawn, on the map 100 (shown in the sidebar in FIG. 8b), without moving the pawn across the map. The application can simply identify the screen location of Bob's pawn and then change the application information of Bob's pawn to match the same location as Andy's pawn.

From there, all of the above-discussed proximity and privacy rules apply—if Bob is in a private conversation, Andy will still need to Wave or Knock before he can join.

FIG. 8c shows Andy having teleported to Bob's location. Andy's pawn 102A is now near Bob's pawn 102B, in the upper left corner of the map 100. However, Bob and Charlie's conversation is still private as indicated at 154 so as discussed above, Andy neither hears Bob and Charlie or views their video on his display (or views them in a grayed-out form). Andy will still need to Wave or Knock in order to join.

Say Andy actually does find Bob on the map. In other words, he does not have to resort to using the list view. Then Andy can select Bob's pawn and choose Wave or Knock. If Bob accepts the Wave/Knock, Andy will automatically be teleported to Bob's location on the map and will be joined into the conversation.

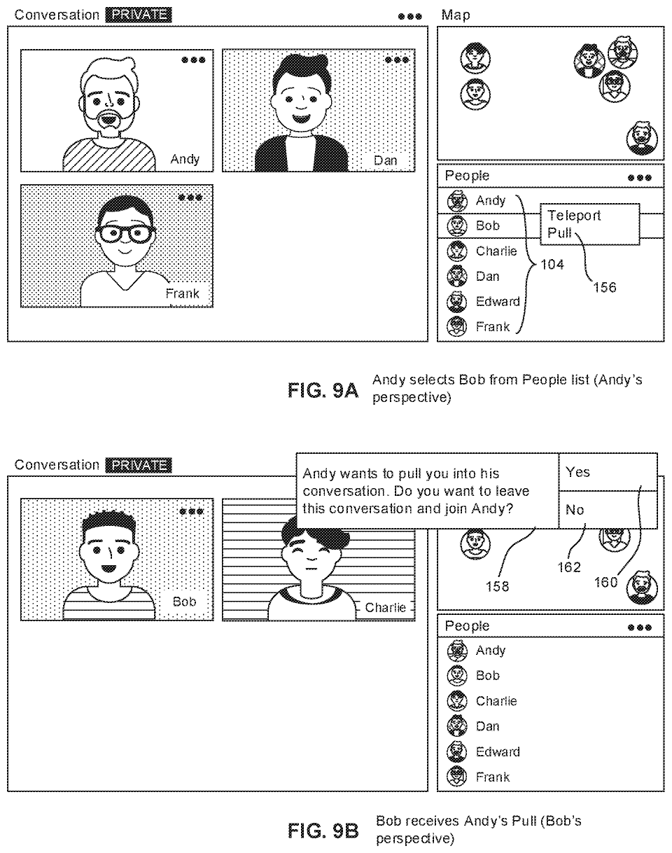

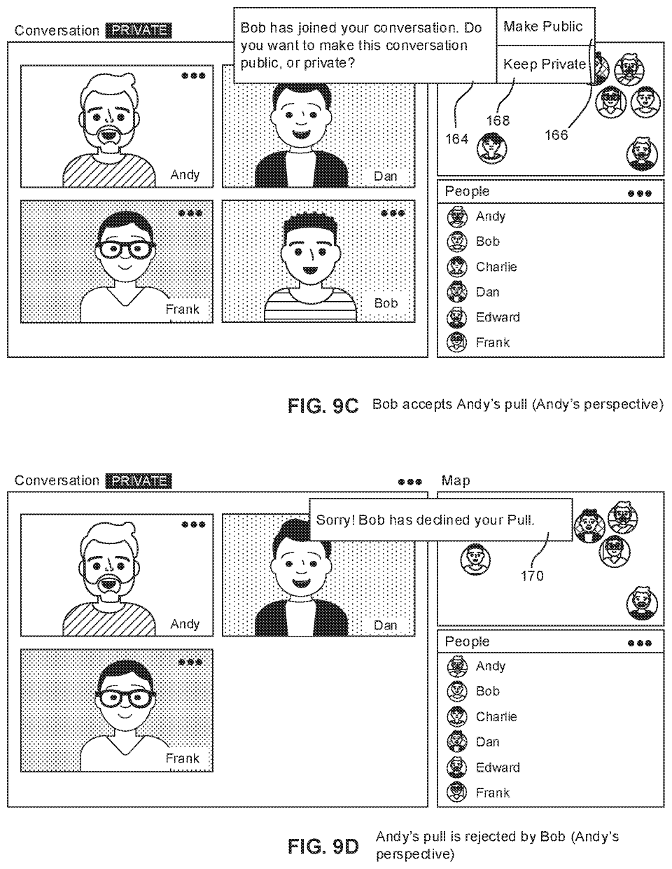

FIGS. 9a-9d illustrate a Pull function to request a chat participant join an ongoing conversation in a chat subgroup. Whereas Teleport transports a participant to a conversation somewhere else on the map, Pull transports someone else to the pulling participant's location to join a conversation.

In the example shown, assume Andy, Dan, and Frank are in a conversation. They start discussing something that Bob knows a lot about. Andy can select Bob from the list 104 in the sidebar and select Pull 156.

In response, FIG. 9b is a screen shot of Bob's display presenting a notification 158 that Andy is trying to pull him into a conversation. If Bob accepts the Pull using the yes selector 160, he is teleported to wherever Andy is on the map, and he is automatically added to the conversation as illustrated in FIG. 9c. If Bob rejects the Pull using the no selector 162, Andy receives a notification that Bob is not available at the moment.

FIG. 9c shows Bob being joined to Andy's conversation (using a screen shot of Andy's device) after accepting the pull solicitation. Bob can now see videos of and hear Andy, Dan, and Frank. Bob's pawn is also moved over to Andy's on the map 100, and Andy is notified at 164 that Bob has joined. Andy may select a public selector 166 to make the conversation public or he may select the private selector 168 to maintain the (now four-way conversation private.

If Bob declines the pull solicitation, FIG. 9d shows Andy receiving a message 170 informing him that Bob has declined his pull. Bob remains in his prior conversation, with Charlie.

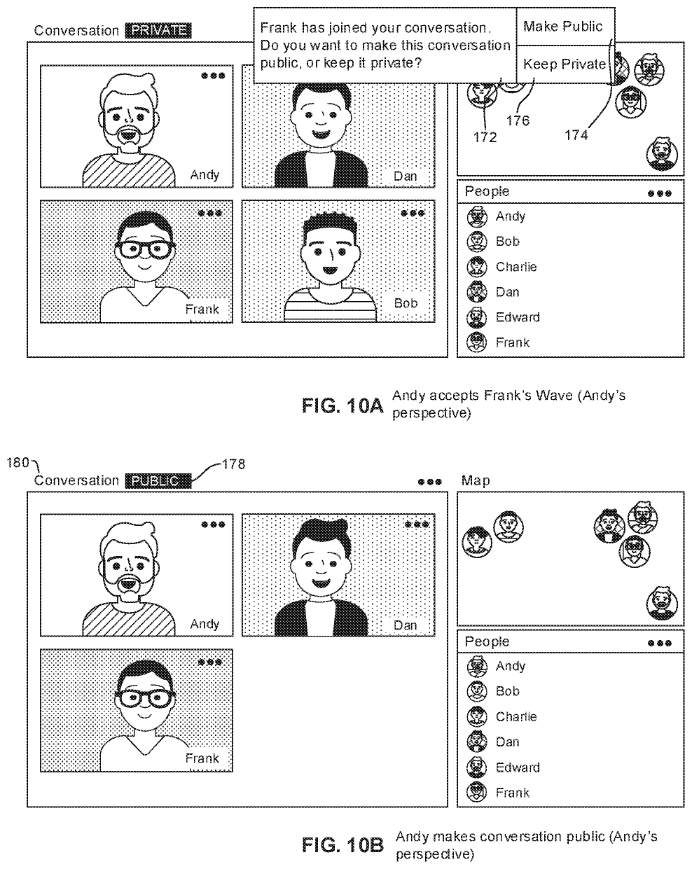

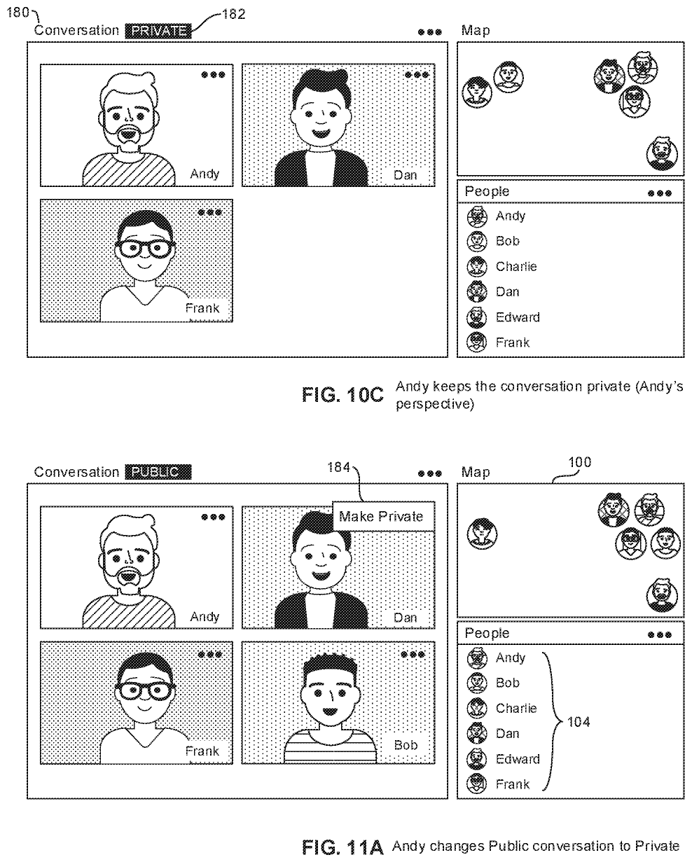

FIGS. 10a-10c illustrate a Wander function to emulate the dynamics of real-life social interaction in a large group setting of the ability to wander around the room, quietly observing and sampling conversations before choosing one to join. By moving his pawn around the map 100, a user can “wander by” different groups, seeing and hearing them once nearby. This allows a user to sample the content of different conversations before choosing one to join.

FIG. 10a illustrates (on Andy's device) that Frank has navigated his pawn nearby. Note that Andy is in a two-way conversation with Frank only, and a conversation between only a pair of chat participants may be made private by default. If that pair agrees to make their conversation public even before anyone else joins the map, then it will be public when more people arrive, and those new people can easily join the conversation.

As mentioned above, if two people are in a private conversation and a third person requests to join, a Wave or Knock may be accepted by the conversationalists or declined. In FIG. 10a Andy and Dan are talking privately and Frank waves as indicated to Andy at 172, and Andy can accept the Wave using the selector 174 and make the conversation public so that Frank can join, the situation illustrated in FIG. 10b. This not only allows Frank to join, but it also allows anyone else who approaches in the future to join, without a Wave or a Knock. Andy can also select to keep the conversation private at 176.

FIG. 10b shows that the conversation between Andy, Dan, and Frank is now public, as indicated by the Public tag 178 in the Conversation header 180. However, as shown in FIG. 10c, Andy may accept Frank's Wave but choose to keep the conversation Private using the selector 176 in FIG. 10a. Frank is allowed to join, but anyone else in the future will also need to Wave or Knock in order to join. This can be seen by the Private tag 182 in the Conversation header 180.

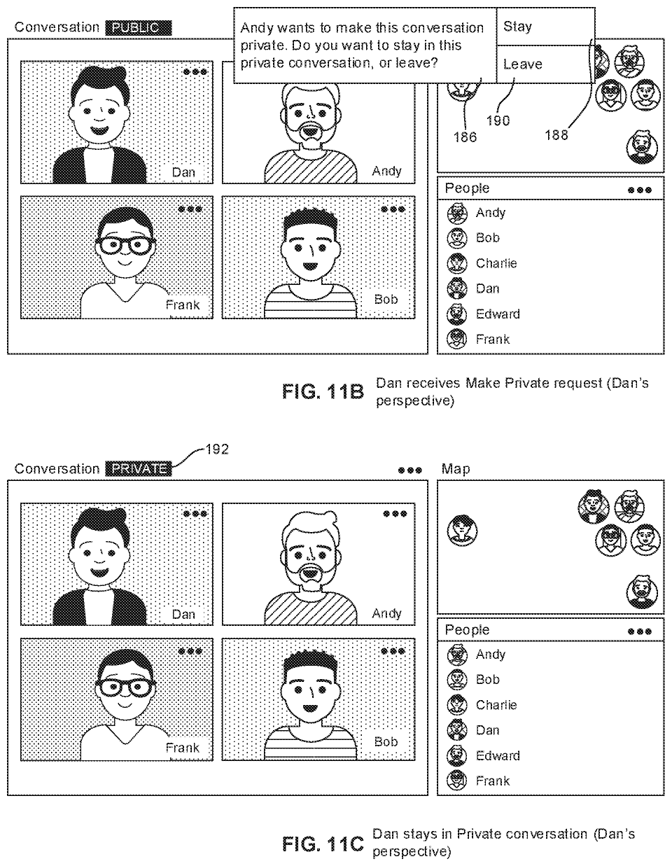

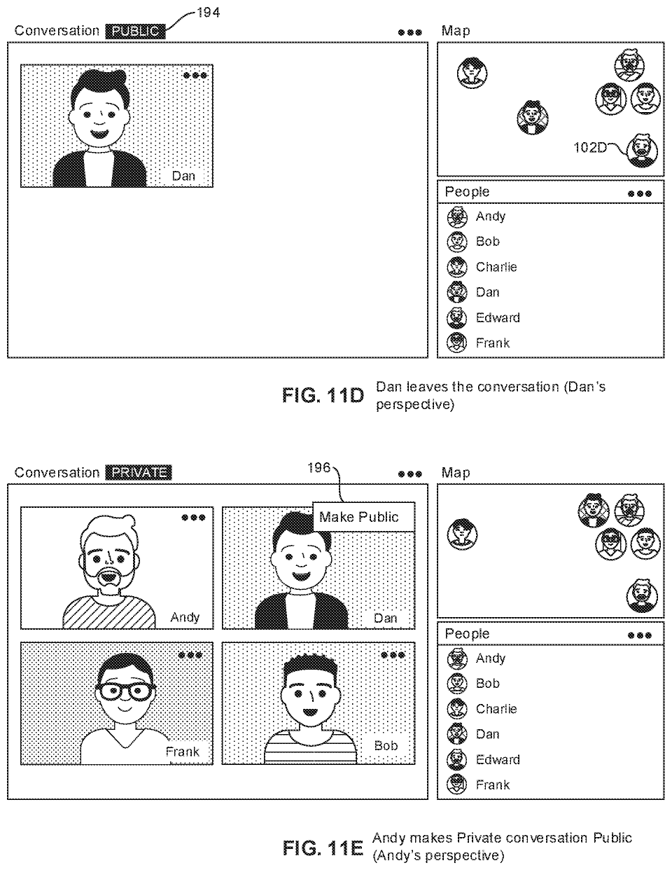

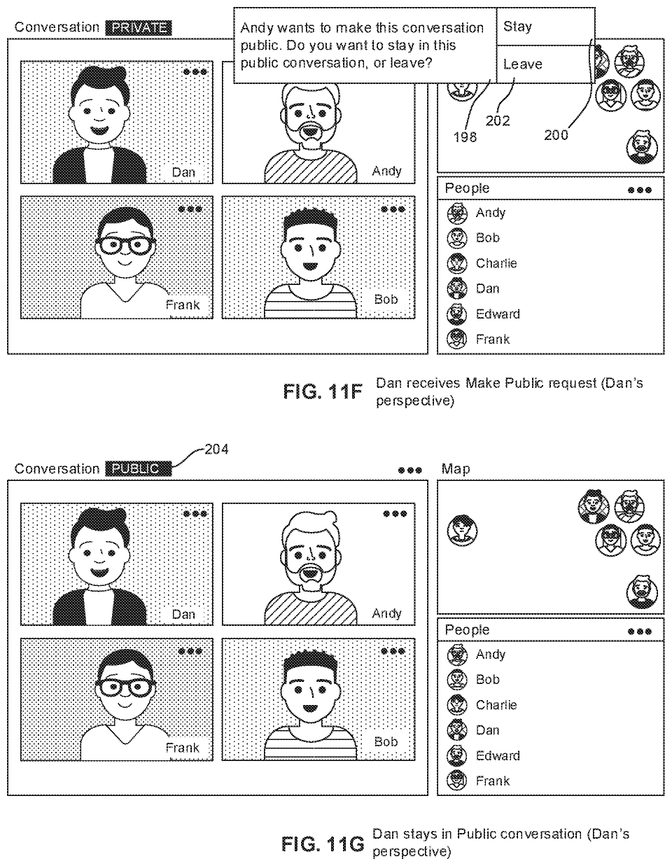

FIGS. 11a-11g illustrate aspects related to switching between public groups to private groups, and back again. Assume Andy, Dan, and Frank are in a public conversation in FIG. 11a, and they begin discussing a private topic. Any one of them can select the Options menu and select Make Private 184. This will send a privacy request to all the members of that conversation. Each member has the option to either accept or reject that privacy request.

FIG. 11b illustrates (using a screen shot of Dan's device) that members of the sub-group (in this case, Bob, Dan, and Frank) receive a message 186 indicating that Andy wishes to make the conversation private, and the members (in this case, Dan) can agree by selecting the stay selector 188 (which results in the screen shot of FIG. 11c) or may elect to leave the conversation using the selector 190 (resulting in FIG. 11d).

In other words, once one member of a conversation requests to make it private, the others in the conversation have the option to either participate in the private conversation or leave the conversation and go find someone else to talk to.

FIG. 11c shows Dan choosing to stay in the Private conversation. The Conversation header now shows a Private tag 192. However, in the event that Dan does not wish to remain in the solicited private conversation, FIG. 11d illustrates Dan's video on Dan's device without videos or audio of Andy, Bob, or Frank. Also, note that Dan's pawn 102D has been moved to an isolated area of the map, so he is removed from all conversations. He cannot see or hear or anybody else's video. Because he is alone, his conversation is Public as indicated by the tag 194.

Members who reject the privacy request may be asked to confirm if they want to leave the conversation. If they confirm, they will be unable to see/hear those who accepted the privacy request as shown in FIG. 11d. If they decline, they will again be given the option to accept the privacy request.

The reverse mechanic (private-to-public) is similar. Refer to FIG. 11e and assume Andy, Dan, and Frank are in a private conversation, during which any of them can select Options to invoke a selectable Make Public selector 196. In response, Andy's device sends a request 198 as shown in FIG. 11f to the devices of the other members of the sub-group. Using Dan's device as an example, Dan can either agree to make the conversation public by selecting the stay selector 200, or Dan can decide to leave the conversation by selecting the leave selector 202. FIG. 11g illustrates a screen shot from Dan's device resulting from selection of the stay selector 200. The Conversation header now shows a Public tag 204. If Dan chooses to leave the conversation, he will end up in the same state as shown in FIG. 11d.

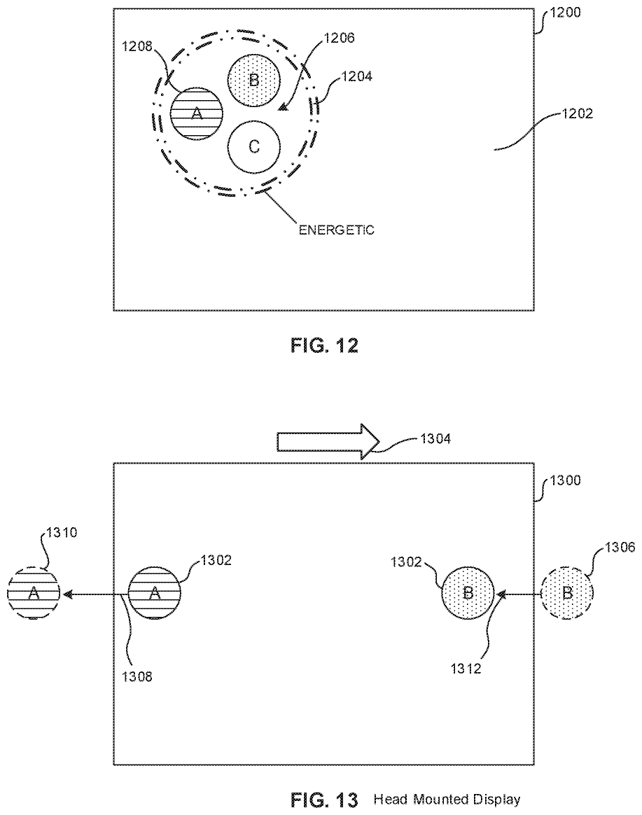

FIG. 12 illustrates a display 1200 such as may be implemented by any display described herein showing a map portion 1202 of the UIs described herein with an indicator 1204 proximate to a subgroup 1206 of chat participants 1208 engaged in video chat with each other. In the example shown, the indicator 1204 is a colored halo around the subgroup 1206 that may be animated and colored in accordance with metadata associated with the conversation. For example, using voice and image recognition of the participants 1208, keywords may be extracted from the conversation using semantic analysis (to indicate the subject of the conversation) and emotion may be identified, with the appearance of the indicator 1204 being established according to the subject and emotional tone of the conversation. For example, the indicator 1204 may be colored red and may be animated to pulse to indicate an excited or angry emotional state, whereas for a relaxed emotional state the indicator may be green and may be animated to present a smooth wave propagating around the periphery of the indicator. Text may also appear with keywords indicating the conversation topic, such as “sports”, “politics”, and the like. In this way, a chat participant not in the subgroup 1206 may be aided in deciding whether to ask to join the subgroup.

FIG. 13 illustrates a HMD 1300 which may move objects 1302 (such as video images of users in the wearer's subgroup or pawns of chat participants in the map) on and offscreen as the wearer turns his head, in the example shown, to the right as indicated by the arrow 1304. Thus, in the example shown, object “A” initially is presented on the left of the HMD 1300 and as indicated by the dashed lines 1306, object “B” is not yet presented. As the wearer turns his head, object A is animated to move left, as indicated by the arrow 1308, until it is no longer shown as indicated by the dashed lines 1310, whereas object B has moved onto and past the right edge of the display, as indicated by the arrow 1312.

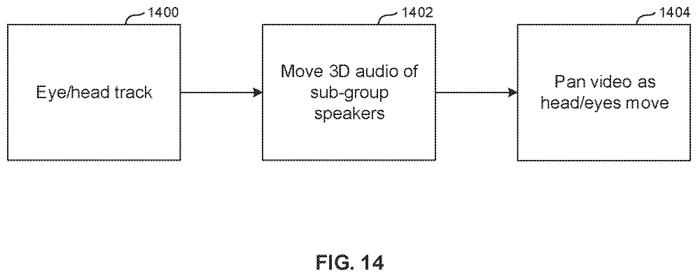

FIG. 14 illustrates further. Using one or more cameras on the HMD 1300, at block 1400 head- and/or eye-tracking tracks the gaze of the wearer of the HMD. Moving to block 1402, both video and audio (such as 3D audio) are moved on the HMD according to the movement of the wearer's head. For example, speaker delays in the HMD can be varied to emulate changes in perceived real world audio as a person might experience them when turning his head from one conversation partner to another, and audio also can be attenuated or amplified as appropriate as the wearer walks around a room “away” and “toward” emulated location of conversation partners. Block 1404 indicates that video also is moved by, e.g., panning to maintain the center of the view along the person's line of sight.

Note that face capture may be executed at block 1400 as well, mapped onto a 3D skeleton image, and provided to the devices of other chat participants as the video of the wearer of the HMD.

Note further that assets in the map may define screen space. For example, if the map models a dinner party, a participant's proximity to others around the table defines to whom the participant may speak and hear.

It is to be understood that the map need not emulate one big open area and instead can alternatively emulate public and private rooms. A room may be used to apply more specific, stringent rules about who can participate, and how. For example, in a movie room, a feature film may be playing, with member audio disabled by default so people watching the movie are not disturbed by people talking. However, the whisper function still works, so people can have short private conversations, just like in a real movie theater.

In contrast, a game room may present a sports game or a video game in which member audio is not disabled to allow members to cheer and chant and otherwise express their enthusiasm for what they are watching. If a video game is being played, then control of that game can be passed to another member of the room via Share Play. This can allow for things like a virtual couch or virtual arcade experience, with players trading off control of the game while others watch and cheer.

A music room is contemplated in which one user is in control of the music that is playing, emulating a DJ. Anyone who enters can hear the music in addition to their voice chat. The Options menu can include options like Ask to DJ, Request a Song, etc.

A panel discussion room may be instantiated in which a few members (the “panel”) are allowed to talk and can be seen. Anyone who enters the room is part of the audience. The audience can see and hear the panel, but their audio and video are disabled by default. The Options menu might include an Option like Raise Hand or Ask Question to send a request to the panel moderator. If accepted, the requestor's mic and video are shown to the panel and the audience for the duration of the question.

A private meeting room can be associated with a whitelist of people who are allowed to enter. It may also conceal the identity of the people in the room, by anonymizing the pawns. Anyone on the whitelist can enter the room. The existence of the room may also be gated by the whitelist—if a member is not on the list, the member does not know if the room's existence.

A presentation room can have a presenter and an audience. The presenter may be the only one whose video and audio is visible. In addition, the presenter can share his screen and everyone in the audience can see it. Like panel discussions, this can include a Raise Hand or Ask Question option.

Restricted rooms can have rules about which members can enter, such as age restrictions (adults-only rooms). They may also have a warning that the user must accept before joining, so warn of potentially offensive topics or situations such as nudity or adult language.

Without limitation, present principles may be applied to virtual house parties, in which participants are emulated as being located in a big empty map, free to move about and socialize. Present principles may apply to a virtual convention with thousands of attendees, with the map being a replica of a convention center floor plan. Chat participants navigate around the show floor, visit different booths, listen to demos or panels, network with colleagues, have private meetings, etc.

Or, the map may be skinned to match the layout of an office floor plan, with cubicles, meeting rooms, common areas, etc. Chat participants can have virtual stand-ups, private meetings, public lunches, social events, happy hours, etc.

A further application relates to speed dating or speed networking in which the map is configured like a speed dating event, with different tables set up around the room. Chat participants on one side of the table could say static. Every few minutes pawns on the other side of the table can be rotated to move them one table to the left or right. Each would be a private pair conversation where people can get to know each other. They can exchange contact info if they want to keep the conversation going.

While particular techniques are herein shown and described in detail, it is to be understood that the subject matter which is encompassed by the present application is limited only by the claims.

1. An assembly comprising:
at least one display;
at least one network interface; and
at least one processor configured with instructions to:
receive information via the network interface pertaining to plural chat participants;
using the information, present on the display a user interface comprising:
a map window showing icons or avatars each respectively representing a chat participant, wherein all of the plural chat participants are represented on the map window, the UI further comprising a video chat window separate from the map window and presenting videos of respective users in a subgroup of chat participants, the users being less than all of the plural chat participants, a user in the subgroup of chat participants being presented with an option to pull a user not in the subgroup of chat participants into the subgroup of chat participants, the user not in the subgroup of chat participants being presented with an option to accept to join the subgroup of chat participants in response to the user in the subgroup of chat participants selecting the option to pull the user not in the subgroup of chat participants into the subgroup of chat participants.

2. The assembly of claim 1, wherein the assembly comprises at least one speaker and the instructions are executable to:
present on the speaker audio from users in the subgroup but not from other chat participants not in the subgroup.

3. The assembly of claim 1, wherein the subgroup is established based at least in part on proximity based at least in part on proximity of respective icons or avatars to each other in the map window.

4. The assembly of claim 1, wherein the UI comprises:
a list window presenting a list of all chat participants represented in the map window.

5. The assembly of claim 1, wherein the instructions are executable to:
present the map window in a primary region of the display and present the video chat window in a sidebar portion of the display; and
responsive to user input on the primary region or on the sidebar portion, swap display locations of the map window and the video chat window.

6. The assembly of claim 1, wherein responsive to a first user in the subgroup of chat participants navigating a respective icon or avatar away from the subgroup, the instructions are executable to shrink in size, on a display associated with the first user, the video chat window of the subgroup and diminish a volume of chat of the subgroup on a speaker associated with the first user.

7. The assembly of claim 1, wherein the display comprises a virtual reality (VR) or augmented reality (AR) head-mounted display (HMD).

8. The assembly of claim 1, wherein the instructions are executable to:
configure the video chat window of the respective users in the subgroup of chat participants in a public mode, wherein a first chat participant moving a respective icon into proximity of the subgroup can see videos of the users in the subgroup and hear audio from the users in the subgroup; and
configure the video chat window of the respective users in the subgroup of chat participants in a private mode, wherein the first chat participant moving a respective icon into proximity of the subgroup cannot see videos of the users in the subgroup or hear audio from the users in the subgroup.

9. The assembly of claim 8, wherein the instructions are executable to:
responsive to a request from the first chat participant to enter the subgroup while in the private mode, present on a display of at least one of the users in the subgroup an interface to reject or accept the first chat participant.

10. The assembly of claim 1, wherein the instructions are executable to:
present on a display associated with a first chat participant a list of chat participants represented by respective avatars or icons in the map window; and
move the respective avatar or icon of the first chat participant to a location in the map window of an avatar or icon of a second chat participant selected from the list.

11. A method comprising:
presenting on respective display devices of respective chat participants a video chat application simulating real-life social dynamics at least in part by:
providing an onscreen map to each display device showing pawns representing respective chat participants;
permitting users in subgroups of the chat participants to engage in conversations while viewing videos and hearing audio from members of the respective subgroups;
moving chat participants between subgroups responsive to the respective chat participants moving their pawns on the map;
presenting the map in a primary region of the display and presenting a video chat window in a sidebar portion of the display; and
responsive to user input on the map, or the video chat window, or either or both, presenting the map in the sidebar portion of the display and presenting the video chat window in the primary region of the display.

12. The method of claim 11, comprising:
presenting on the display devices of users in a first subgroup audio from users in the first subgroup but not audio from other chat participants not in the first subgroup.

13. The method of claim 11, wherein a first subgroup is established based on proximity of respective pawns to each other in the map.

14. The method of claim 11, comprising presenting on the display devices at least one user interface (UI) comprising:
a list window presenting a list of all chat participants represented in the map.

15. (canceled)

16. The method of claim 11, comprising:
enabling first and second users of at least one of the subgroups to enter a whisper mode in which at least a third user of the at least one of the subgroups of the first and second users cannot access communication between the first and second users.

17. The method of claim 11, wherein at least one of the display devices comprises a virtual reality (VR) or augmented reality (AR) head-mounted display (HMD).

18. The method of claim 11, comprising:
configuring a video chat window for a subgroup in a public mode, wherein a first chat participant moving a respective icon into proximity of the subgroup can see videos of the users in the subgroup and hear audio from the users in the subgroup; and
configuring the video chat window for the subgroup in a private mode, wherein the first chat participant moving a respective icon into proximity of the subgroup cannot see videos of the users in the subgroup or hear audio from the users in the subgroup.

19. A system comprising:
at least one video chat server;
plural devices communicating with the chat server, each device being associated with a respective user;
at least one processor configured with instructions to:
present on each device a map with pawns representing the respective users;
present on at least one device a video chat window along with the map and showing video of at least first and second users based on respective first and second pawns being proximate to each other on the map;
present the map entirely in a first display region and present the video chat window entirely in a sidebar region; and
responsive to user input on at least one of the map or the video chat window, present the map window entirely in the sidebar region and present the video chat window entirely in the first display region.

20. The system of claim 19, wherein the first and second users are in a chat subgroup, and the instructions are executable to:
enable a third user who is not in the chat subgroup to enter the chat subgroup using a first request;
enable the third user to enter the chat subgroup to using a second request; wherein the first request is visually distinguished as being more urgent than the second request on at least one display of at least the first or second user.
